(19) United States
(12) Patent Application Publication
(10) Pub. No.: US 2022/0129804 A1
(43) Pub. Date: Apr. 28, 2022

(54) Systems and Methods for Integrated Technology Risk Management

(71) Applicant: McKinsey & Company, Inc., New York, NY (US)

(72) Inventors: Rachel Dooley, Mount Kisco, NY (US); Elizabeth Grennan, New Canaan, CT (US); James Edward Boehm, Sykesville, MD (US); Andrew David Burt, Washington, DC (US)

(21) Appl. No.: 17/240,536

(22) Filed: Apr. 26, 2021

Related U.S. Application Data
(60) Provisional application No. 63/106,524, filed on Oct. 28, 2020.

(51) Int. Cl. G06Q 10/06

(52) U.S. Cl. CPC G06Q 10/0635; G06Q 10/067

(57) ABSTRACT

Systems, apparatuses, and methods provide a tool for project and organizational risk awareness and management. The tool may take the form of a set of user interface elements, a set of processes, and a risk management methodology. The tool operates to combine risk assessment experts and technology experts into a common approach or function. This assists in providing a realistic assessment of the risk associated with a project or task, including its impact on an organization as a whole. The integrated risk evaluation and management platform may enable consideration of the mitigation steps that are presently being used, that may be available but are not presently being used, or that are required or should be considered to manage a type or source of risk.

### CROSS REFERENCE TO RELATED APPLICATIONS

This application claims the benefit of U.S. Provisional Application No. 63/106,524, entitled “Systems and Methods for Integrated Technology Risk Management,” filed Oct. 28, 2020, the disclosure of which is incorporated, in its entirety (including the Appendix), by this reference.

### BACKGROUND

Risk evaluation and legal advice regarding risks and risk remediation are important to the operation of organizations for both practical and legal reasons (such as for preventing harm, ensuring compliance with regulations, and reducing potential liability). This type of evaluation and the advice provided by an organization's legal department are important to identifying and reducing the organization's risk from a variety of sources, including liability for breach of an agreement, representation or warranty (whether express or implied), and/or violation of a regulation or statute. This evaluation can also aid an organization in making informed decisions concerning resource allocation and task prioritization, where these types of decisions can be made more efficiently and correctly when a comprehensive view of the risk(s) related to providing services and technology development, use, implementation and maintenance is available.

Unfortunately, the risk evaluation and legal advising functions of an organization are generally external to, and distant from (in an organizational sense), a technology or product development team. This results in product and service development often being performed independently of risk evaluation or a proper review by a legal department until a new product or service has been developed and is ready to be marketed or released. As a result, legal issues that are found or recommended changes may require delays in product release, renegotiations with customers, setting aside funds to address the risk, or performing a costly redesign of the implementation of a particular capability of a product.

Further, when risk evaluation and legal experts are brought into a project after technologists have performed a substantial amount of innovation and product or service development, it may be too late to make the changes the legal experts recommend to best protect the organization. This can be the case where the product or service has already been deployed or is in production. In addition, the risk evaluator and/or legal team may lack sufficient context to properly identify and calibrate the risks associated with a project, resulting in an approach that may be perceived by those affected as being overly strict and heavy-handed, and therefore as an impediment to the operation of other functions of an organization. This can harm relationships between the legal and risk functions and other parts of the organization, leading to poor communications and tension between those implementing the legal/risk functions and those who should be seeking their advice.

Additionally, the legal and regulatory considerations relevant to some emerging areas of technology development and use continue to evolve rapidly (e.g., data privacy, AI regulation), as does public perception of these areas and the potential reputational risk to an organization (e.g., that arising from the use of open source software in corporate environments). This can make it even more difficult to provide reliable advice at later stages of product or service development if previous development work is based on out-of-date information or an incorrect understanding of the legal and regulatory situation.

Further, legal, regulatory and perception changes can be responsible for increased risk for a specific project and/or combine to create a significant level of risk or change in risk when applied across multiple technology development efforts or deployments. As a result, a comprehensive view of the risk sources and available mitigation tools for both a specific project and across multiple projects can enable an organization to better address these sources of risk and changes to risk.

Thus, systems, apparatuses, and methods are needed for more efficiently and effectively evaluating the risk associated with a specific project or task and the mitigation processes being used for the task. Systems, apparatuses, and methods are also needed for more efficiently and effectively determining whether further mitigation or other risk evaluation is needed to protect an organization, either due to the specific task and/or due to the risk from multiple projects or tasks. Embodiments of the disclosure are directed toward solving these and other problems individually and collectively.

### SUMMARY

The terms “invention,” “the invention,” “this invention,” “the present invention,” “the present disclosure,” or “the disclosure” as used herein are intended to refer broadly to all of the subject matter described in this document, the drawings or figures, and to the claims. Statements containing these terms should be understood not to limit the subject matter described herein or to limit the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments of the disclosure are directed to systems, apparatuses, and methods for evaluating the risk due to a specific project or task, taking into account the current risk mitigation efforts being used for the project or task. The project or task may include use of a specific technology, dataset, or metadata and the risk arising from use of that technology, dataset, or metadata may be a contribution to the risk for the project or task. Embodiments are also directed to using the risk due to the specific project or task as a factor in determining the overall risk arising from a plurality of projects or tasks being performed throughout an organization. Embodiments are also directed to determining if an additional or modified mitigation process or technique should be used for a task, project, or organization. This determination may be based at least in part on considering whether a risk metric for the task, project, or organization exceeds a threshold or trigger value. In some embodiments, a risk metric may take the form of a risk vector that comprises risk contributions from multiple categories or types of risk (such as regulatory, credit, IP, political, reputation, etc.). The individual risk contributions may be combined into a single metric or value based on a set of weights, a form of a norm or distance measure, etc.

In some embodiments, the threshold or trigger value may be capable of being set or adjusted by a user. In some embodiments, benchmark data may be used to set or suggest a value for the threshold or trigger, or to recommend implementing additional mitigation efforts to reduce risk. In such embodiments, a decision process to determine if additional mitigation is recommended or required may implement logic that includes consideration of user inputs to a risk threshold and/or benchmark data. The benchmark data permits a user to consider the mitigation behaviors and techniques of other companies or organizations (such as those in a similar industry) when deciding whether to initiate additional mitigation measures or to adjust current mitigation methods or the level of mitigation to reflect behavior more in keeping with that practiced within the industry. This can be important in determining an organization's liability, as it is generally important that an organization practice risk mitigation and management techniques that would be considered reasonable and standard within an industry to avoid liability for negligence.

In some embodiments, one or more rule-based or trained models may be used to classify a dataset, project, or task and assign a corresponding risk score, risk level, risk range, or other form of risk related metric. In some embodiments, a trained machine learning (ML) model may be used to classify a task or project (or other form of the work being considered) with regards to its risk. As mentioned, the currently available or applied risk mitigation methods may be considered in classifying a task or project to generate a corresponding risk metric. The generated risk metric may then be compared to a threshold or trigger value to determine if an additional, different, or modified mitigation process should be considered. As will be described in greater detail, the threshold or trigger may be set by a user, an expert, and/or determined by logic that includes consideration of benchmark data. In some embodiments, the decision as to whether to implement a new mitigation method, replace an existing method with a different method, or adjust a currently applied method may include logic that considers benchmark data or other factors provided by a user or expert when a risk metric exceeds a threshold value.

In some embodiments, a second rule-based or trained model, or form of logic may be used to combine the risk metrics from a set of tasks or projects to determine an overall risk metric for an organization. As with the determination of a risk metric for a specific task or project, the currently available or applied organizational-level risk mitigation methods may be considered in generating a corresponding organizational risk metric. The generated risk metric may then be compared to a threshold or trigger value to determine if an additional, different, or modified mitigation process should be considered. As will be described in greater detail, the threshold or trigger may be set by a user, an expert, and/or determined by logic that includes consideration of benchmark data. In some embodiments, the decision as to whether to implement a new mitigation method, replace an existing method with a different method, or adjust a currently applied method may include logic that considers benchmark data or other factors provided by a user or expert when a risk metric exceeds a threshold value.

In some embodiments, a third rule-based or trained model, or form of logic may be used to adjust or modify an output of the second set of rules, model, or logic to account for an individual organization's current risk concerns, other organization-specific concerns at that time, and other information not considered in the benchmark data. For example, a specific organization may have an increased averseness to risk or to a specific component of an overall risk metric due to recent legislation, industry events, sensitivity of their customers or investors, a recent decision from an executive, etc. The third set of rules, model, or logic permit an organization's risk management team to modify weights of risk components, scale an overall risk measure, and otherwise introduce considerations that may not be present in the user inputs or benchmark data used in the first and second evaluation processes for task and overall organizational risk.

The risk evaluation and advice provided by the legal department of an organization (or outside counsel) as a result of the evaluation processes described herein can impact product and service development in several ways. As examples, when a new, revised, or additional mitigation process is recommended or required, it may include, but is not limited to one or more of (a) requiring an additional level of review before authorization is given for a product release, project agreement, or sale of a product or service, (b) suggesting a redesign to a task, or to a product or service to reduce risk by implementing a feature or capability in a different manner (such as by modifying, adding, or eliminating a capability or product feature), (c) renegotiating the terms of a proposed agreement or task description, (d) requiring a change to an existing risk-related reserve fund or escrow account to provide greater resources in case of a risk-related event, or (e) triggering a need for additional review or mitigation actions when a change to the risk (or a new risk) presented by a project or deployment (or by multiple projects or deployments) causes the introduction of an additional risk factor or a significant enough change to the overall risk to an organization.

Because of the importance of understanding sources of risk and managing that risk in ways that minimizes the harm to an organization, the systems, apparatuses, and methods described herein can be of value to several different departments and levels of operation of an organization, including but not limited to Executive, Board of Directors, Operations, Finance, Legal, and Project or Program Management.

Other objects and advantages of the system, apparatuses, and methods described will be apparent to one of ordinary skill in the art upon review of the detailed description and the included figures. Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### BRIEF DESCRIPTION OF THE DRAWINGS

Embodiments of the present disclosure will be described with reference to the drawings, in which:

FIG. 1 is a flowchart or flow diagram illustrating a process, method, function or operation 100 for determining a risk score or metric for a specific task, project, or organization and in response, determining whether additional mitigation or risk evaluation is needed for the task, project, or organization, in accordance with some embodiments.

FIG. 2 is a flowchart or flow diagram illustrating a process, method, function or operation for using an output from a trained model or rules-based process that is part of the process flow shown in FIG. 1 to determine whether additional risk mitigation, review, or evaluation is needed for a specific task or project and/or for an organization based on consideration of benchmark data, user weighting, or other user-specified data, in accordance with some embodiments.

FIG. 3 is a flowchart or flow diagram illustrating a process, method, function or operation for combining a set of risk metrics or vectors for a plurality of tasks or projects into an overall organizational risk vector or metric, in accordance with some embodiments.

FIG. 4 is a diagram illustrating elements or components that may be present in a computer device, server, or system 400 configured to implement a method, process, function, or operation in accordance with some embodiments.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, controller, etc.) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

Accurate and timely risk evaluation is a key element in providing comprehensive and practical legal advice to an organization. Because of the importance of legal advice to the safe and effective operation of an organization, it is desirable that such advice be provided in an efficient manner to each of the multiple operational areas of the organization. This suggests that risk analysis and advice regarding compliance with legal and regulatory constraints (and any related mitigation efforts) may need to be made available to project managers, marketing, sales and the responsible people involved in the development of products, services, and technology in a timely manner. Further, this advice should ideally be based on a current understanding of the legal and regulatory environment, which for emerging technologies may be in flux. This also suggests that not only task or project specific risk should be considered, but also organization-wide risk should be considered when deciding on appropriate risk mitigation efforts or a need for approval of an activity, project, or task.

As mentioned, the risk evaluation and advice provided by the legal department of an organization (or outside counsel) as a result of the evaluation processes described herein can impact product and service development in several ways. When a new, revised, or additional mitigation process is recommended or required, it may include, but is not limited to one or more of (a) requiring additional levels of review before authorization is given for a product release or sale of a product or service, (b) suggesting a redesign to avoid or reduce risk by implementing a product feature in a different manner, such as by modifying, adding, or eliminating a capability or product feature, (c) renegotiating the terms of an agreement, or (d) triggering a need for additional review or mitigation actions when a change to the risk (or a new risk) presented by a project or deployment (or by multiple projects or deployments) causes the introduction of an additional risk factor or a significant enough change to the overall risk to an organization. Because of the importance of understanding sources of risk and managing that risk in ways that minimizes the harm to an organization, the systems, apparatuses, and methods described herein can be of value to several different departments and levels of operation of an organization, including but not limited to Executive, Board of Directors, Operations, Finance, Legal, and Project or Program Management.

As mentioned, the practical needs of an organization to make decisions and take steps towards executing on projects or tasks suggest that the type of risk evaluation tool described herein should ideally be available to a number of people within an organization so that they can provide input data for at least the first evaluation process prior to moving too far with a task or project. Further, the overall organizational risk and related evaluation processes should ideally be available to the legal department and/or specific risk assessment and management executives so that decisions affecting organizational risk mitigation practices can be made by those individuals. Further, the outputs of the risk evaluation processes should ideally be available on-line and in real-time or pseudo real-time so that risk related decisions can be made in an efficient and accurate manner.

Embodiments of the systems, apparatuses, and methods described herein provide a tool for project and organizational risk awareness and management. Embodiments of the tool may take the form of one or more of a set of user interface elements, a set of processes, and a risk management methodology. The tool operates to combine risk assessment experts (typically legal department personnel) and technology experts into a common approach or function. This assists in providing a realistic assessment of the risk associated with a project or task, including its impact on an organization as a whole. In some embodiments, the approach may also enable consideration of the mitigation steps that are presently being used, that may be available but are not presently being used, or that are required or should be considered to manage that risk. From one perspective, embodiments provide a tool for monitoring product or service development and the associated risk, and addressing (and in some cases, mitigating) that risk, including products and services that an organization may use internally.

Among other benefits and advantages, the tool and methodology described herein assists in addressing legal considerations and the associated risk(s) substantially in real-time or concurrently with, instead of after, product or service development. The systems, apparatuses, and methods also provide a methodology to identify and address these considerations in an order or manner proportional to the risk (or potential risk) associated with a specific project or task. In some embodiments, the tool and methodology may include consideration of benchmarks representing the organization's industry and the industry practices for similar projects or tasks. In some embodiments, the tool and methodology incorporate feedback or adaptive learning such that the data generated by a model may be used as part of the training data, labeling, or weighting of the model or of another model; in this way, the accuracy, predictive and analytical value of the tool and methodology may increase over time.

In some embodiments, the tool and methodology may include consideration of information regarding active projects or tasks, and near-real-time metrics for an organization's activities. This can allow the organization to focus on management and mitigation of the risks that exist as a project or task is performed, as opposed to hypothetical risks. In some embodiments, the tool and methodology may be configured to access and incorporate information and metrics from similar organizations in an industry, from examples using a similar technology for a task or project, or from examples of similar types of projects. This may assist in benchmarking efforts within the organization and also externally in comparison to similar organizations or organizations in the same industry or sector. In some embodiments, internal and/or external risk metrics may be input to a model, where such metrics provide (or can be converted to) threshold risk values that are applied when determining whether to trigger a specific risk mitigation effort (e.g., benchmark data may be used to train a model on the number of data sources considered “high risk” that, when present, create a need to adjust mitigation triggers and requirements).

Among other recommendations, the inventive system and methods might recommend that additional testing be performed related to security controls or unpermitted bias stemming from a dataset, model, or project, to cite two sources of risk. Such recommendations could involve implementation of additional access controls, policies related to permitted use of data, or specific methods for bias and remediation testing related to the underlying dataset, model, or project. Recommendations may reduce risk by increasing compliance with existing risk standards and, consequently, by reducing the risk (or occurrence) of undesirable security, performance, or other events that may cause harm.

In some embodiments, the risk mitigation efforts may include, but are not limited to or required to include escalation to an expert or other decision maker, enforcement of a new mitigation requirement, or a required confirmation of the use of a mitigation method (including modifying a recommended effort to one that is required). For example, the risk assessment processes may identify a significant number of projects being pursued within an organization that use data that identifies individuals, which due to the existence of personal data could be considered a “high risk project”. The risk assessment process may also identify 10 or more external data sets containing such personal data, and the organization determines this combination of personal data+10 sources being used requires independent review. As a result, the risk evaluation processes may in the future recommend an independent review for such combinations in similar situations. In this sense, the risk models may “learn” or be modified to “know” that this risk prediction for tasks identifying individuals plus certain external data sources represents (or should represent) a trigger for a mitigation process in the form of an independent task review. As another example, if when the benchmark data (internal or external) is considered, a threshold value for additional mitigation is 7 as opposed to 10 datasets, then in response, the threshold value for the number of datasets to trigger this mitigation action may be changed from 10 to 7. Similarly, the risk models may consider the benchmark data and revise their predictions or classifications in evaluating similar “high risk” or “higher risk” projects.

In some embodiments, the systems, apparatuses, and methods may be implemented as a platform or service for use by both legal, product development, technical, executive, and risk evaluation personnel (which in some cases may be members of the legal department, IT department, executives, etc.) within an organization. Among other capabilities, the platform enables the monitoring of a project or task (or a collection of projects or tasks), the identification of potential risks and evaluation of the level of risk (which may take into consideration benchmark data or an acceptable level of risk for the organization, industry, or other entity), and in some cases, may identify recommended risk mitigation requirements (such as an escalation for proper review and authorization). These capabilities or functions may be performed with reference to a specific project and/or for the organization overall when multiple projects or tasks are considered in determining the risk profile for the organization. The platform may generate and update risk metric data that may be used to benchmark the risk associated with a type of project or use of a type of technology across multiple use cases and industries. The platform and its decision processes may be (re)calibrated (such as by revising thresholds for triggering specific risk mitigation actions) as new data is available and the machine learning model continues being trained by means of a feedback loop or similar mechanism.

In some embodiments, a first evaluation process may be used to determine a risk measure or metric associated with a specific task or project. This process may consider as an input information and data that define or characterize aspects of the project or task. For example, the input information may include one or more factors such as a size of an organization, an industry sector of the organization, a jurisdiction in which a dataset originated, a jurisdiction in which a project will be deployed, a number of datasets involved, a type of dataset involved or the type of data included in a dataset, a source of a data set and whether specific rights have been obtained regarding use of the data, a number of personnel involved in training or deployment of a model used as part of a task or project, a number of input features used by the model, etc. The input information may be acquired from responses to a questionnaire, from accessing information placed into a file by people working on a task or project, from fields of a data record containing information about a task, etc.

Although it may not be apparent, each of these characteristics or factors my impact a risk assessment. For example, a jurisdiction with existing regulatory requirements relevant to a project could result in a higher risk “score” than a jurisdiction without such regulatory requirements. Similarly, certain types of data associated with a person (e.g., geospatial data that could be used to track and locate a single unique identifier associated with a person or device) could be considered a factor that increases risk in comparison to anonymized data. As another example, a model relying on multiple third-party data sets, or data sets associated with reputational risk or unclear rights-to-use from the data source, could increase risk in comparison to models relying solely on an organization's internal data.

In some embodiments, these characteristics or factors may be identified based on the experience of an “expert” who is familiar with the factors or characteristics that should be considered in a risk assessment for a task. For example, a senior member of a legal department or a group of employees experienced in addressing risks in different operational areas may be consulted to develop a list of factors that should be considered when evaluating the risk associated with a task. In some embodiments, these areas of potential risk may include one or more of regulatory, information technology (IT), data privacy, intellectual property (IP) rights, political, exchange or monetary, credit, reputation, etc.

In some embodiments, the characteristics or factors may be presented as questions to a program or project manager. The responses to the questions may represent “values” for the factors that serve as an input to a rule-set or trained machine learning model. In some embodiments, a group of such questions may be structured as multiple sets of related questions, with a keyword or characteristic serving as an indicator that a specific set is relevant to assessing the risk associated with a task or project.

In some embodiments, some or all of the information or data used as an input to a rule-set or trained model may be obtained semi-automatically or automatically. In these embodiments, a contract, task description, proposal, or memorandum describing a proposed task or project may be used as the basis for generating the inputs to the rule-set or model. For example, this may be accomplished using an NLP or other text classification or extraction engine to “interpret” a document and generate a set of inputs to serve as predicates for a rule-set or “features” for input to a trained model. In some embodiments, an image of a document, combined with OCR and NLP (optical character recognition and natural language processing) techniques may be used to interpret and extract information from a document.

In some embodiments, these factors or features may be derived from a statistical analysis of what data or information about a task is strongly correlated with (or indicative of) a result or decision that the task is one having a certain level or degree of risk. In this type of analysis, a large number of categories of information may be used initially as possible candidates for a set of important factors or features, with the number being reduced as certain categories are found to have a minimal impact on a risk metric that considers those categories. This form of sensitivity analysis may be used to reduce an initial set of possible factors/features down to a more manageable set that can be used as part of training data for a model or rule-set.

In some embodiments, the risk evaluation process for the task or project may also consider the mitigation methods or techniques currently being used for the task or project. As non-limiting examples, the mitigation related information or data may be represented as one or more of the names of existing risk protocols being used, a quantitative evaluation of the number of risks each protocol addresses (e.g., a numeric representation related to the comprehensiveness of each protocol), an indicator as to whether a protocol addresses sensitive or regulated data, an indicator as to whether a protocol addresses personal protected data, and an indicator as to whether a protocol includes a monitoring program, among other information.

For example, the existence of an organization wide internal program or department that independently reviews types and sources of external data may be considered a more substantial risk mitigant compared to a vetting process (such as a norm established at the organization level) that is done by a project team, which in turn may be considered a more substantial risk mitigant than an approach that is typically ad hoc (such as one that is not consistent across the organization, and done by a project team at their own initiative). Likewise, the existence of a second line risk team to assess and address risks related to a project may be considered a more significant risk mitigant than a single person responsible for multiple project teams and connected with a project after the project has been defined and begun to be executed. Thus, among other possible factors in weighting the impact of a mitigating action or process is whether it is typically ad hoc or organization wide, whether it is required in all cases or its use is subject to a project manager's decision, and whether it is general or specific to the characteristics of a project.

In some embodiments, one or more rule-based or trained models (or other form of decision logic) may be used to classify a dataset, project, or task and assign a corresponding risk score, risk level, or other form of risk related metric. In some embodiments, a trained machine learning model may be used to classify a task or project (or other form of the work being considered) with regards to its risk. As mentioned, the currently applied risk mitigation methods may be considered in classifying a task or project to generate a corresponding risk metric. The generated risk metric may then be compared to a threshold or trigger value to determine if an additional or different mitigation process should be considered. As will be described in greater detail, the threshold or trigger may be set by a user, an expert, and/or determined by logic that includes consideration of benchmark data. In some embodiments, the decision as to whether to implement a new mitigation method or adjust a currently applied one may include logic that considers benchmark data or other factors provided by a user or expert when a risk metric exceeds a threshold value.

For example, a project that could have a direct impact on health and human safety may be determined to require a dedicated second line risk specialist on the project team as a form of risk mitigation. Similarly, a project that could result in processes or data processing pipelines (such as trained models or an expert system) that are in production for multiple years may require an independent process review to assess the planned process for stability, safety, security, etc. as a form of risk mitigation. Finally, a combination of certain risk factors and a resulting higher risk “score” may trigger an additional recommended risk mitigation—e.g., a project that would result in controlled technology being deployed in certain jurisdictions would require legal specialist consultation (e.g., US ITAR (International Traffic in Arms Regulation) or the EAR (Export Administration Regulation) guidance).

As another example, an input to a rule-set or trained model (and hence a possible factor in determining a risk evaluation metric) used in assessing an overall organizational risk may be the number of projects being undertaken that have a specific source of risk associated with them or are in a specified category of risk. In some embodiments, this situation might cause a change to a risk metric threshold or to the logic that determines whether to recommend an additional or modified mitigation technique. Similarly, the number of tasks or projects having a risk metric value that exceeds a threshold or falls within a specific range for task risk might cause a change in a risk threshold value for one or more of the components of an overall organizational risk vector or for an overall organizational risk value. Further, in some embodiments, a combination of certain task or project characteristics may be the source of a recommendation to adjust an existing set of mitigation measures or techniques.

If available, benchmark data may comprise benchmarks based on task or project features (such as type of data being used, jurisdiction in which task is being implemented, etc.), organizational features (size, revenue, employee count, trends, etc.), and industry features. The benchmark data may be presented to a user to assist the user in setting the risk metric threshold values that result in recommending a new mitigation procedure. In some embodiments, the benchmark data may be used as part of a process that automatically sets a threshold value based on a benchmark or a proportion of a benchmark.

As mentioned, in some embodiments, a form of decision process may be used to determine if a task risk assessment that exceeds a threshold value is sufficient to cause the system to recommend or require an additional (or modified) mitigation procedure. For example, a risk assessment for a task might be required to exceed a threshold value by an amount sufficient to cause the risk metric to equal or exceed a relevant benchmark risk value to result in an additional or modified mitigation procedure being recommended or required. Similarly, a task risk metric might be required to have increased by a specified percentage or amount over a certain period of time to result in an additional or modified mitigation procedure being recommended or required. As another example, a task risk metric may be required to exceed the threshold value for a specified amount of time (e.g., two quarters) to result in an additional or modified mitigation procedure being recommended or required.

In some embodiments, a user may be presented with a user interface that enables them to select a desired additional mitigation technique or to modify an existing one based on a display of one or more of a task or project risk vector or overall metric, an organizational risk vector or overall risk metric, and benchmark data for a task, project or organization. As mentioned, benchmark data may be relevant because of the organization's characteristics (size, location, revenue, etc.) or industry, among other aspects.

In some embodiments, a second evaluation process, which may be comprised of one or more rule-based or trained machine learning models, or other form of logic for combining task or project risk metrics, may be used to determine an overall risk profile (which in some cases may be expressed as a risk vector, measure, or metric) for an organization, based on a plurality of tasks or projects being performed by the organization. The input information or data may include a risk metric determined by application of the first evaluation process to each of the plurality of tasks or projects. In some embodiments, the input information may be a risk vector for each task or project, where the vector represents a risk measure for each of a set of risk categories or vector components that are associated with the task or project. The second evaluation process may also consider the mitigation methods or techniques currently being used by the organization at an organizational level (which may differ from those used for a specific task or project).

An overall risk profile for the organization may be based on combining the individual task risk metrics using a set of predetermined or learned weights. The weights may reflect the relative contribution to the organization of the revenue from a project, the number of employees involved in a project, the potential harm to the organization from a project if certain events occurred, or another relevant factor. In some embodiments, an overall risk profile may be represented as a risk vector, with the vector including total risk metric values for each of a set of risk categories or components (such as regulatory, data privacy, credit, reputation, etc.).

The risk vector may be used to generate a scalar risk value for the total organizational risk arising from the risk associated with each category by using a specific formula for generating a single value from the components of a vector. This formula may depend on the dimensionality or other characteristic of the vector space, such as the relationship of one vector component to another. The risk associated with each category may be determined by combining the risk for that category for each of a set of tasks or projects. The weights used when combining the risk values for each of a set of tasks for a specific category and/or when combining the total risk for a set of categories into an organizational risk metric may be based on one or more of user specified weights, benchmark data, a distance metric for determining a scalar value (a norm) from a set of vector components (e.g., Euclidean, non-Euclidean, etc.), and a learned set of weights.

In some embodiments, the weights applied to the individual task metrics may be based on (or adjusted by) considering when a set of projects that involve a similar source of risk combine to create more than an additive amount of risk due to that source. For example, for an organization that grows from using a single external data source to dozens of third-party data sources, the system may recommend establishing an internal organizational process for evaluating all forms of data-related risk. Similarly, an organization undertaking projects that consistently result in a relatively high value for a risk metric may be directed to establish an independent second line of risk professionals. This can be beneficial as the cumulative risk arising from multiple risk events could result in a higher possible harm/penalty than would be expected from the total obtained by summing separate harms or penalties (such as in the case of a regulatory penalty in which damages are multiplied if a certain level of harm or malfeasance is found).

The generated risk metric for the organization (both as a single value and as risk values for each of the risk vector components representing each category of risk) may be compared to a threshold or trigger value to determine if an additional or different mitigation process should be considered. The threshold or trigger may be set by a user, expert, and/or determined by logic that includes consideration of benchmark data. In some embodiments, the decision as to whether to implement a new mitigation method or adjust a currently applied one may include logic that considers benchmark data or other factors provided by a user when a risk metric exceeds a threshold value.

In some embodiments, a third rule-based or trained model, or other form of logic may be used to adjust or modify an output of the second set of rules, model, or logic to account for an individual organization's current risk concerns, other organization-specific concerns at that time, and information not considered in the benchmark data. For example, a specific organization may have an increased averseness to risk or to a specific component of an overall risk metric due to recent legislation, industry events, regulatory issues, customer feedback, sensitivity of their customers or investors, a recent decision from an executive, etc. The third set of rules, model, or logic permit an organization's risk management team to modify weights of risk components, scale an overall risk measure, and otherwise introduce considerations that may not be present in the user inputs or benchmark data used in the first and second evaluation processes for generating task and overall organizational risk.

In some embodiments, information used to adjust the output of the second risk evaluation process that determined the overall risk due to multiple tasks or projects may include one or more of a user's or organization's desired settings for (a) threshold values, (b) weighting factors, (c) a distance metric used to determine the overall risk metric from the risk vector components, (d) an indication of the relative risk averseness of the organization, and/or (e) desired adjustments (addition, subtraction, scaling) to the organizational risk metric due to consideration of benchmark data, for example. In some embodiments, the output of the third evaluation process is an adjusted overall organizational risk metric or vector based on the contributions from multiple tasks or projects and may include consideration of user or organizational preferences, benchmark data, or other factors that impact how a user or organization interprets risk related activities. As with the outputs of the first and second evaluation processes, the rule-set or model used in the third process (or a subsequent one) may also generate one or more recommendations or suggested risk mitigating actions.

In one sense, the third rule-set or model may be used to fine-tune the overall risk metric (and/or risk vector) for an organization formed from combining the individual risk metrics for multiple tasks or projects. Although the metric for each task and for the organization overall takes into account benchmarks, user weights and possibly other factors, the third rule-set or model (which may be in the form of a set of factors that can be applied instead of a formal model) allows each organization to modify the overall risk metric based on information that is internal to the organization or to incorporate current organizational risk concerns. It may also allow a modification to the computed organizational metric based on more current benchmark data.

In addition, the third evaluation process provides a user with a last chance to review the previously set weights or metric combining methods and change them to reflect the current risk approach of their own organization. This may better account for organizational specific information, concerns, and preferences. This allows an adjustment for (or incorporation of) the changing risk landscape and risk tolerance of an organization. For instance, if an organization determines that user privacy and autonomy is a new and core concern for users of its products and services, then the organization can interact with the third rule-set or model directly to lower the threshold values for triggering additional or modified mitigation around use of personal data. The third rule-set or model can also suggest raising thresholds for related risk triggers, e.g., direct marketing models that identify personal attributes to certain personas even if not strictly personal data, use of biometric data, etc. Some of these actions may be informed by benchmark data from a relevant sector as well as from model training data introduced by external experts that introduces new data as the external risk landscape changes. As an example, where use of biometric data is becoming increasingly concerning to users in a sector, the training data for the model may include new reputational risk concerns and this change will influence the adjusted organizational risk metric.

In some embodiments, the risk metric (or one or more components of a risk vector) determined for a specific project, task, or for the organization may be used to generate new training data for one or more of the models. This enables each evaluation process to adapt over time as more examples of data and risk metrics are determined and refined by users. For example, if a new or modified mitigation process is recommended, then if it is implemented, the trained model may be used to generate an updated risk metric. The descriptive information for a task and the updated metric may then be used as training data for the model.

As mentioned, in some embodiments, the systems, apparatuses, and methods described herein may be used to determine if a new, revised, or additional mitigation process should be applied (or required if that is appropriate) for a specific task or for the organization as a whole. In some embodiments, this decision may be based on whether an overall risk metric for a project or task, or for an organization meets or exceeds a threshold value. In some embodiments, the threshold value or the logic for deciding if a risk metric that exceeds a threshold value should result in a new, revised, or additional mitigation process may depend on one or more of a user's input, an expert's decision, a benchmark for the type of task, a benchmark for the type of industry to which the task is related, a benchmark for the technological use case involved, or a combination of those factors. In some embodiments, if the risk metric exceeds a threshold, then additional logic may be executed to determine whether to recommend or instead require a specific mitigation process.

As mentioned, in some embodiments, the integrated risk evaluation platform or system described herein includes one or more risk evaluation processes, rule-sets, or models. These may take the form of a rule-based risk evaluation engine or a trained machine learning model, or in some cases another form of logic executed by a programmed processing element. In one example embodiment, a set of data relating to or characterizing a task or project is collected or accessed.

The set of data may include one or more of:
Factual indicators characterizing a specific task or project that have been found to be relevant or helpful in evaluating risk (such as “features” of a trained model, or a precondition of a rule in a rule-based engine);
   for example, categories of data being used for (or by) a projector task, the industry involved, responses to questions that provide information regarding aspects of a task or project that may require investigation;
      note that the questions used to collect this information and to assess a task or project may initially be generated by an “expert” familiar with an organization's approach to risk management—as more is learned about the risks presented and the appropriate risk management for other organizations, the questions may be selected automatically by use of a trained model;
   project stage—this may be a relevant consideration for some types of projects, as the project life cycle may be a factor in the risk analysis—e.g., an early stage vs. a late stage project may combine with other factual indicators to trigger additional mitigation actions or requirements;
Mitigation indicators relevant to the task or project;
   for example, data and information related to or identifying mitigation processes that are currently in place in an organization and/or for a specific task and how they may be triggered or how they operate, where this may include one or more of;
      risk prevention or risk remediation protocols, along with an indication of when, or the conditions under which, a protocol is triggered;
      rules defining when escalation to a different process, mitigation level, or decision maker is required to obtain approval for a task;
      whether a provision for automated review of certain technology (e.g., an automatic code review program) is in place;
      whether a requirement for automated gating of specific types of technology work (e.g., code cannot be pushed out to a staging environment without appropriate sign off or authorization, or machine-generated code review) is in place;
      whether a requirement for additional resources (e.g., the amount/type of advanced analytics being done by an organization requires a Model Risk Management (MRM) team and approach) is in place;

The rule-based risk evaluation model and/or one or more trained machine learning models receive as an input the mitigation and/or factual indicators, and generate or provide as an output a risk evaluation score, level, or metric;
the risk evaluation metric may be a score, number range, risk level, etc.
   the risk evaluation metric may be used as an input to a decision process comparing the metric to a threshold or trigger value, with the outcome of the comparison being used to determine whether to apply a specific protocol or risk remediation process or to modify one currently being used for the situation;
      the threshold or triggering value may be modified by a user and/or be set by comparison with a benchmark (such as being set equal to or equal to some portion of a benchmark risk metric for similar projects, organizations, industries, etc.);
   the output of the rules model or machine learning model (after any adjustments arising from user selection or based on benchmark data) may be provided in a feedback loop to the rule base model or machine learning model to improve performance or provide a form of supervised learning;
   if a change to the currently implemented mitigation procedures is recommended, then if it is adopted, the trained model or rule-based engine may be executed again with the task specific data and the updated set of mitigation procedures to generate a revised risk metric for the task—the output of the rules model or machine learning model (after any adjustments arising from use of the change to the mitigation procedures) may be provided in a feedback loop to the rule base model or machine learning model to improve performance or provide a form of supervised learning;

Benchmark data reflecting a risk metric associated with a specific industry, task type, region, type of organization, etc. may be used as part of setting a risk metric threshold, as a factor in logic used to determine whether to recommend or require a different mitigation procedure, as an initial baseline risk value until a more granular metric can be developed, etc.;
such data may be used as an input to a rules-based or machine learning model as an initial label/annotation to a set of data for an organization;
   in one example, organization-specific data may be annotated with an initial risk metric value derived from benchmark data for a similar organization (e.g., with regards to size, revenue, industry, management structure, etc.)—as more is learned or determined to be relevant to the specific organization, the risk metric may be revised based on user inputs, an output of a trained model, etc.;
   as a trained model or rule-set is refined through a feedback loop of input data and a revised metric value, benchmarks may be updated and/or replaced by organization or task specific information;
   benchmark data, or a comparison of a task or organization risk metric with benchmark data, may trigger a need for additional input from a development team (e.g., new questions introduced in the tool), which could trigger additional mitigation recommendations or requirements;
      In some embodiments, other data and metadata related to datasets, projects or models, or organizations may be ingested by the trained model(s) or rule-based engine(s), which themselves may comprise one or more models, as set forth above.

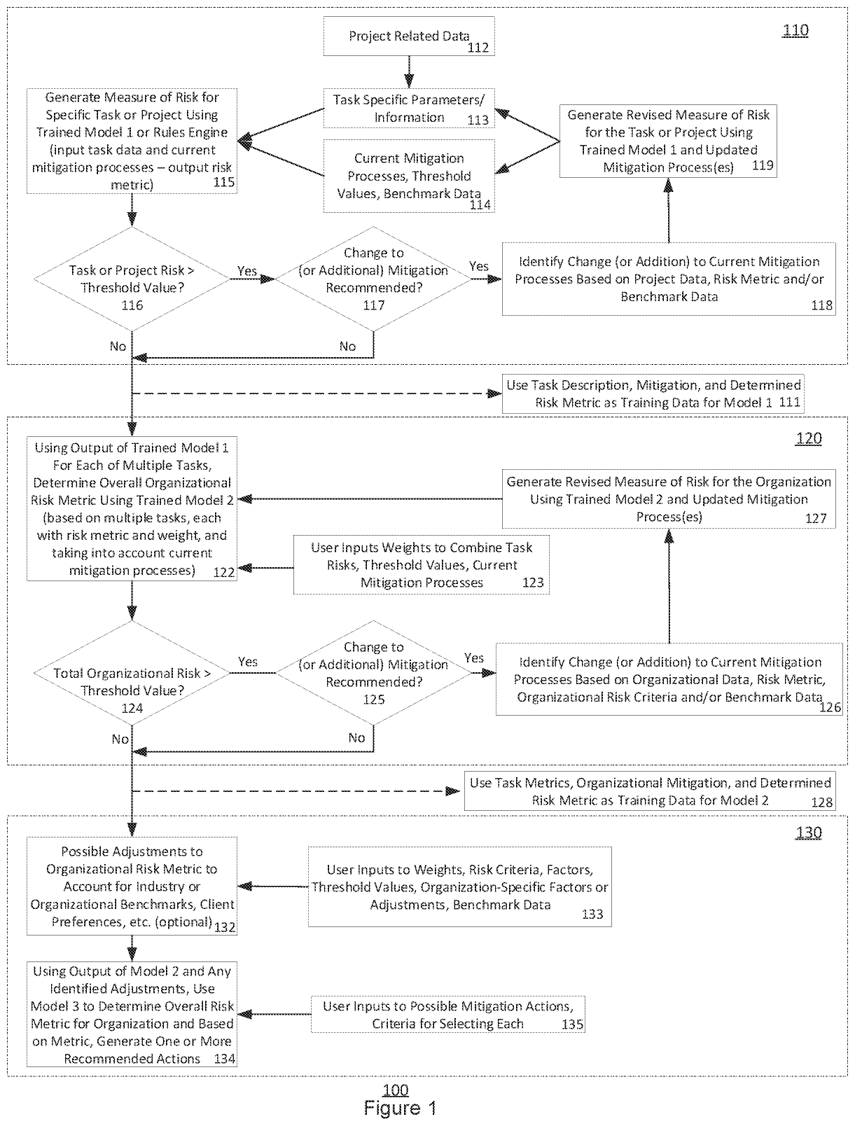

FIG. 1 is a flowchart or flow diagram illustrating a process, method, function or operation 100 for determining a risk score or metric for a specific task, project, or organization and in response, determining whether additional mitigation or risk evaluation is needed for the task, project, or organization, in accordance with some embodiments. In the example embodiment illustrated in FIG. 1, the overall process 100 may be comprised of three primary sub-processes or data processing flows:
a data processing flow or process (110) directed to determining or evaluating the risk associated with a specific task or project;
a data processing flow or process (120) directed to determining or evaluating the overall risk associated with a plurality or set of tasks or projects being performed within or by an organization; and
a data processing flow or process (130) directed to adjusting, modifying, or otherwise changing the risk determined or evaluated by process 120 based on additional information or parameters, where this information or these parameters may comprise one or more of:
   a user input to adjust a risk metric or a component of a risk metric vector of an organization based on:
      risk-averseness of an organization;
      updated or more specific benchmark data;
      regulatory changes;
      customer or vendor concerns;
      newly identified risk factors;
      newly important organizational initiatives; or
      estimates of potential liability, etc.

As shown in FIG. 1, a risk evaluation or risk management process for a specific task or project 110 may be initiated by collecting or acquiring task or project specific data (as suggested by step or stage 112). The task or project specific data may be obtained (as non-limiting examples) from responses to a questionnaire, accessing task data from a set of stored records (such as agreements, project descriptions, project proposals, contracts, etc.), or other suitable source. In some embodiments, a natural language processing (NLP) model or text recognition process (such as optical character recognition combined with a text extraction and interpretation model) may be used to review documents and extract words or phrases to populate a set of task specific parameters or information (as suggested by step or stage 113), where these are used as inputs to a rule-set or trained model. In some embodiments, a process that is part of an integrated risk evaluation system may access stored records, parse those records, and extract specific data or information from the records. In some implementations, a project or program manager may have access to or be able to provide the data and may enter the data into an integrated risk evaluation system that implements all or a portion of process flow 100 using a suitably configured user interface.

The task or project related data 112 may be refined into the task specific parameters or information used as inputs to the trained model or rule-based engine 115, as suggested by step or stage 113. This may comprise extraction of data or information from response fields in a questionnaire or data records. Information regarding the currently utilized mitigation processes is provided to the model or rule-based engine 115 by a process illustrated at step or stage 114. This may include an initial set of threshold values used to determine when a risk metric for a task is sufficient to cause a consideration of whether to implement an additional mitigation process.

The task specific data 113 and mitigation processes currently being used for the task 114 are input to a first trained model or rules engine, as suggested by step or stage 115. The model or engine 115 is configured to process the input data and in response to generate a risk measure or metric for the task. The output risk measure or metric may be represented as a single value (between 0 and 100, between 0 and 10, etc.), as a range of values (e.g., 15-27, 10-50, etc.), or as a label representing a relative measure of risk (e.g., very low, low, low to medium, medium, medium to high, high, very high, excessive, etc.).

In some embodiments, the features on which a machine learning model is trained may include (but are not limited to or required to include) those considered by experienced “experts” to have been indications of increased risk, those identified in the past through experience as indicators of risk associated with a project, or those features found to be statistically correlated with increased risk based on analysis of a sufficiently large set of data regarding previous projects or tasks.

The generated or determined output metric is then compared to a threshold or trigger value, as suggested by step or stage 116. The threshold or trigger value may be set by a user, determined by logic that considers benchmark data, set by a separate processing flow based on a rule-set or trained model (which may take into consideration risk averseness, benchmark data, specific factors or parameters of a task or project, etc.). If the output of rule-set or model 115 is a range or label, a process may be used to map that output to a threshold value or vice-versa (a threshold value may be mapped to a range or label) to permit the comparison at 116.

If the task or project risk exceeds the threshold value (as suggested by the “Yes” branch of step 116), then the process executes a logic flow to determine if an additional mitigation process and/or a change to a present mitigation process is recommended or in some cases required, as suggested by step or stage 117. As an example, the task or project risk may be required to exceed the threshold by a specific amount or percentage, or by a specific amount for a certain time period to cause the logic to recommend or require a change to the present forms of risk mitigation being used with the task or project. As suggested, in some examples, the logic may recommend a modification to the present mitigation techniques being used, while in others (and depending upon the task or project risk metric and the logic executed at 117), the logic may require that a different form of risk mitigation be applied in order to obtain approval for the task or project. As examples, such a change may comprise one or more of removing a present form of mitigation, adjusting a present form of mitigation, or adding a form of mitigation (which may include a form of task review by someone else in an organization).

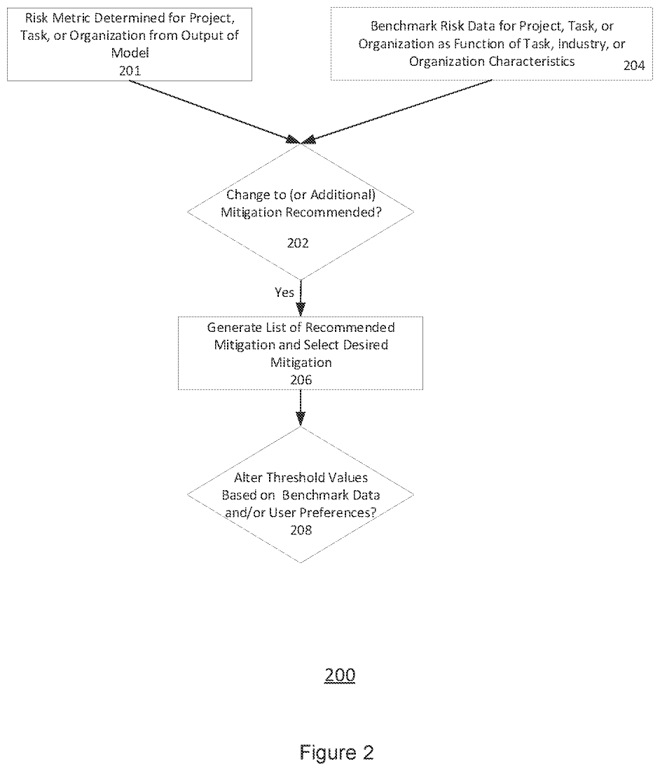

If the logic at step or stage 117 determines that a change to the present mitigation techniques being used with the task or project should be made, then step or stage 118 may be used to determine the nature of that change, based on one or more of task or project information, the determined risk metric for the task or project, benchmark data, a measure of risk averseness, current organizational values or policies, etc. As an example, step or stage 118 may comprise a rule-set used to “convert” a set of inputs related to the task and/or organization into a selection of a specific mitigation measure to be applied or modified. As will be described in further detail, FIG. 2 illustrates a process or logic that may be used to determine if a change to a currently used mitigation technique or set of mitigation techniques is recommended or required, and if so what that change should be, based on organizational and/or benchmark practices.

At step or stage 119, the process 110 generates a revised determination of the risk measure or metric for the task or project based on the task specific information 113 and the modified mitigation techniques being applied (in the case where a recommended mitigation change is accepted or a required one is adopted). This involves using the data or information from 113 and the mitigation techniques from 114 and/or 118 as inputs to rule-set or model 115. This step or stage generates a revised or updated risk measure or metric for the task or project. The cycle of revising the risk metric based on changes to the task information and/or mitigation techniques may continue until the generated risk metric no longer exceeds the threshold value, as determined at step or stage 116 (as indicated by the “No” branch of 116). The final risk metric, task information, and mitigation measures may be used in whole or in part as training data for the rule-set or model executed by step or stage 115, as suggested by step or stage 111.

Given a risk measure or metric as determined by the rule-set or process 115 for each of a set of tasks or projects, step or stage 120 then evaluates the overall risk to an organization based on the set of tasks or projects. As suggested by step or stage 122, a process is executed that combines the risk measures or metrics for the set of tasks or projects into an overall organizational risk measure or metric, taking into account the current mitigation techniques being applied on an organizational level (i.e., those techniques that are not necessarily specific to a task or project, such as an executive level overview, a central review of certain types of tasks, etc.).

The combination of the set of individual task or project metrics may be performed on risk vectors which contain multiple risk category components and scores for each category, or on a single risk measure. Thus, the combining process may generate a result for each component, an overall single risk value, or both. The combining operation may be the result of calculating a weighted sum, applying a rule, fitting values to a curve, applying a filter to remove or level certain components or values, calculating a norm or distance measure from the vector components, or other suitable operation. The combining method or operations may include adjustable values or parameters, which may be set by a user, determined by separate logic, or by another suitable method, as suggested by step or stage 123. At step or stage 123, threshold values and organizational mitigation techniques being used may also be input to process 122. Process 122 may be executed in the form of a rule-set, trained model, a set of mathematical operations executed by a programmed processor, or other suitable method.

In some embodiments, training data for a machine learning model that operates to determine an overall organizational risk metric or risk vector may comprise examples of how an organization desires that the individual risk metrics be combined or filtered, and may include an indication of a overall risk metric that an expert believes should be assigned to a set of task metrics.

The overall organizational risk metric or measure generated by process 122 is then compared to a threshold or trigger value, as suggested by step or stage 124. The threshold or trigger value may be set by a user, determined by logic that considers benchmark data, set by a separate processing flow based on a rule-set or trained model (and taking into consideration one or more of risk averseness, benchmark data, specific factors or parameters of a task or project, etc.). If the output of rule-set or model 122 is a range or label, a process may be used to map that output to a threshold value or vice-versa (a threshold value may be mapped to a range or label) to permit the comparison at 124.

If the task or project risk exceeds the threshold value (as suggested by the “Yes” branch of step 124), then the process executes a logic flow to determine if an additional mitigation process and/or a change to a currently used mitigation process is recommended or in some cases required, as suggested by step or stage 125. As an example, the organizational risk may be required to exceed the threshold by a specific amount or percentage, or by a specific amount for a certain time period to cause the logic to recommend or require a change to the present form(s) of risk mitigation being used. As suggested, in some examples, the logic may recommend a modification to the present mitigation techniques being used, while in others (and depending upon the organizational risk metric and the logic executed at 125), the logic may require that a different form of risk mitigation be applied in order to obtain approval for the task or project. As examples, such a change may comprise one or more of removing a present form of mitigation, adjusting a present form of mitigation, or adding a form of mitigation (which may include a form of review by someone else in an organization).

If the logic at step or stage 125 determines that a change to the present organizational level mitigation techniques should be made, then step or stage 126 may be used to determine the nature of that change, based on one or more of organizational characteristics or data, the determined overall risk metric for the organization, benchmark data, a measure of risk averseness, organizational values or policies, etc. As an example, a rule-set may be used to “convert” a set of inputs related to the organization into a selection of a specific mitigation measure to be applied or modified. FIG. 2 illustrates a process or logic that may be used to determine if a change to a currently used mitigation technique or set of mitigation techniques is recommended or required, and if so what that change should be, based on organizational and/or benchmark practices.

At step or stage 127, the process generates a revised determination of the risk measure or metric for the organization based on the set of individual task metrics and the modified mitigation technique(s) being applied (in the case where a recommended mitigation change is accepted or a require one is adopted). This step or stage generates a revised or updated risk measure or metric (and/or risk vector) for the organization. The cycle of revising the risk metric based on changes to the applied mitigation techniques may continue until the generated organizational risk metric no longer exceeds the threshold value, as determined at step or stage 124 (as indicated by the “No” branch of 124). The final risk metric (and/or risk vector), set of task metrics, and organization level mitigation measures may be used in whole or in part as training data for the rule-set or model executed by step or stage 122, as suggested by step or stage 128.

The overall organizational risk metric as determined by the processes in 120 may then be provided to a third evaluation process, rule-set, trained model, or other form of logic 130. Process 130 may be used to “adjust” the overall organizational risk metric from process 120 to account for updated industry or organizational benchmarks or preferences, client preferences if a version of the integrated risk management system is being provided to a specific client or set of users, considerations of client or industry risk averseness, scaling factors, time-specific factors, weighting factors, etc.

In some embodiments, process 130 may be used to account for an individual organization's current risk concerns, other organization-specific concerns at that time, and information not considered in the benchmark data. For example, a specific organization may have an increased averseness to risk or to a specific component of an overall risk metric due to recent legislation, industry events, regulatory issues, customer feedback, sensitivity of their customers or investors, a recent decision from an executive, etc. Process 130 permits an organization's risk management team to modify weights of risk components, scale an overall risk measure, and otherwise introduce considerations that may not be present in the user inputs or benchmark data used in the first and second evaluation processes for generating task and overall organizational risk.

Process 130 may be used to fine-tune the overall risk metric for an organization; although the metric for each task and for the organization overall takes into account benchmarks, user weights and possibly other factors, process 130 (which may be in the form of a set of factors that can be applied instead of a formal model) allows each organization to modify the overall risk metric and/or risk vector components based on information that is internal to the organization or to incorporate current organizational risk concerns. In addition, this process or model provides a user with a last chance to review the previously set weights or metric combining methods and change them to reflect the current risk approach of their own organization. This allows an adjustment for (or incorporation of) the changing risk landscape and risk tolerance of an organization.

For instance, if an organization determines that user privacy and autonomy is a new and core concern for users of its products and services, then the organization can interact with the third rule-set or model 130 directly to lower the threshold values for triggering additional or modified mitigation around use of personal data. The third rule-set or model 130 can also suggest raising thresholds for related risk triggers, e.g., direct marketing models that identify personal attributes to certain personas even if not strictly personal data, use of biometric data, etc. Some of these actions may be informed by benchmark data from a relevant sector as well as from model training data introduced by external experts that introduces new data as the external risk landscape changes. As an example, where use of biometric data is becoming increasingly concerning to users in a sector, the training data for the model may include new reputational risk concerns and this change will influence the adjusted organizational risk metric.

As suggested by the figure, the output of process 120 may be provided to step or stage 132 where adjustments to the organizational risk vector and/or risk value may be performed or possible adjustments identified, in some cases using as an input user specified weights, scaling factors, threshold values for making adjustments, benchmark data, or other relevant information (as suggested by step or stage 133). Process 132 may include rules or logic that determine if such adjustments are applicable based on the overall organizational risk vector and/or risk value, and the inputs from step or stage 133. If one or more possible adjustments are identified by the process executed at step or stage 132, then step or stage 134 executes a process to adjust the organizational risk vector or risk metric value (or may instead request approval of a proposed adjustment) and may, in some cases, also generate one or more recommended actions. In some embodiments, the process executed at step or stage 134 may utilize as inputs information or data provided at step or stage 135, where such information or data may comprise possible additional mitigation actions, criteria for deciding whether to recommend those actions, etc.

As non-limiting examples, a recommended or required action resulting from the adjusted organizational risk vector or risk metric may comprise triggering an audit of insurance coverage if the metric exceeds a specified value or falls within a specified range, triggering a cyber audit, preventing the completion of certain tasks in a workflow management tool until an audit has been completed or a responsible manager has signed off on a task or tasks, etc. In some embodiments, the recommended or required action may be implemented automatically after determination of the adjusted organizational risk vector or risk metric.

FIG. 2 is a flowchart or flow diagram illustrating a process, method, function or operation 200 for using an output from a trained model or rules-based process that is part of the process flow shown in FIG. 1 to determine whether additional risk mitigation, review, or evaluation is needed for a specific task or project and/or for an organization based on consideration of benchmark data, user weighting, or other user-specified data, in accordance with some embodiments.

As shown in the figure, a risk metric value and/or risk vector produced by either step or stage 115 or 122 of FIG. 1 is provided as an input 201 to a decision process 202 (represented by steps or stages 117 and 125 of FIG. 1) that determines if a change to an existing (or an additional) mitigation process or technique is recommended or required. As shown in FIG., 1, this occurs when the risk metric value or risk vector exceeds a threshold (as suggested by the decision processes at steps 116 and 124 of FIG. 1). An additional input to decision logic 202 may comprise benchmark data 204 for a task, project, or organization, and may be a function of specific task or project data, risk categories, or industry.

Decision process 202 may operate to compare a risk metric and/or vector produced by step or stage 115 or 122 to a benchmark value, to a benchmark value adjusted by a user or rule-set, to a weighting determined by a user input or other set of logic, etc. For example, process 202 may not generate a recommendation to change or enhance existing mitigation processes unless the risk metric or risk vector exceeds the threshold value by a certain percentage, has exceeded the threshold value for a certain amount of time, includes certain component values that exceed a threshold for that component, has a combination of component values that exceed their respective thresholds, etc.

If decision process 202 determines that a change to the current mitigation processes or techniques is recommended or required (as indicated by the “Yes” branch of 202), then process 200 may generate a list of the recommended or required mitigations, present those a user, and receive the user's selection of the modifications to (or addition of) a mitigation process or technique, as indicated at step or stage 206 (represented by steps or stages 118 and 126 of FIG. 1). The selection of the mitigation techniques or processes to present to the user may be based on a criteria or rule, such one or more of the mitigation change or addition expected to have the greatest impact, the expected smallest impact, the industry preferred techniques, the most readily implemented techniques, the techniques required by law or best practices, etc.

In some embodiments, process 200 may also comprise logic or other decision process 208 to automatically (or with user approval) alter one or more threshold values used in steps or stages 114 and/or 123 of FIG. 1, based on benchmark data or user preferences. This enables a user to alter the thresholds used in the other decision processes of FIG. 1 or 2 based on user choice, the application of rules based on a trajectory of the risk metric values, a desire to adjust the outcome of a decision process to an industry, etc.

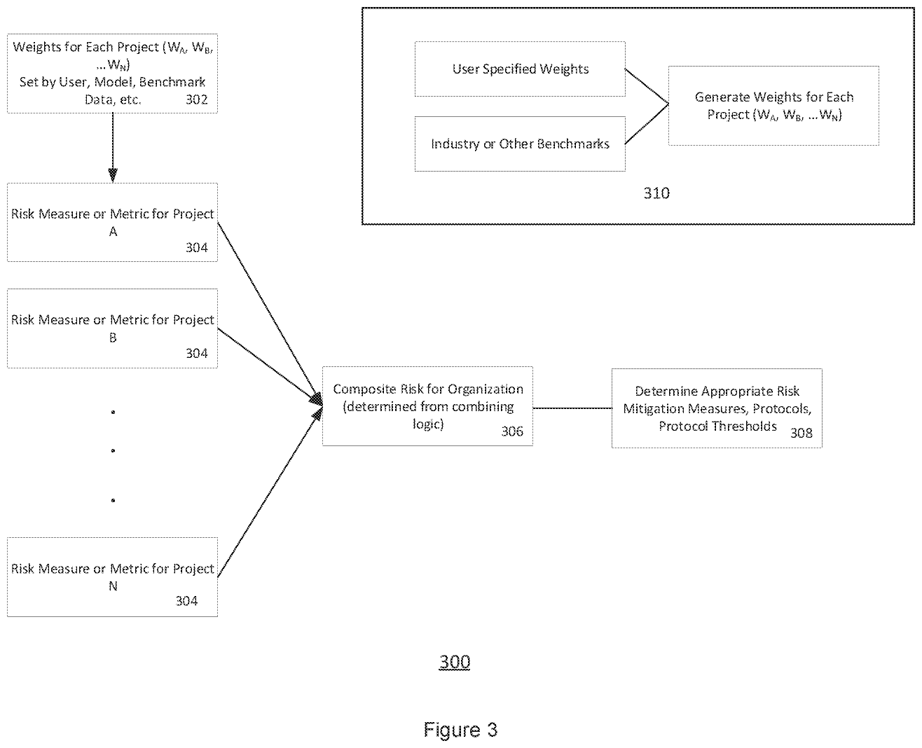

FIG. 3 is a flowchart or flow diagram illustrating a process, method, function or operation 300 for combining a set of risk metrics or vectors for a plurality of tasks or projects into an overall organizational risk vector or metric, in accordance with some embodiments. As shown in the figure, in some embodiments a set of weights for each task or project 302 (indicated by (W_{A}, W_{B}, . . . W_{N}) may be provided to process 300. The set of weights may be determined by one or more of user inputs or settings, benchmark data reflecting the relative importance assigned to certain projects in terms of determining an overall risk measure, etc. Each task or project is associated with a risk metric and/or risk vector, as indicated by risk measures or metrics 304. A composite risk metric and/or risk vector 306 is then computed as a weighted sum, a fit to a curve, a thresholding or filtering, a statistical evaluation of the individual metrics, or other form of combining logic. As described with reference to FIGS. 1 and 2, the composite organizational risk metric and/or vector produced by process 306 may then be used to determine appropriate organizational mitigation techniques, set revised thresholds for triggering changes to or the addition of risk mitigation techniques, etc., as suggested by step or stage 308.

The inset to FIG. 3 (identified as element 310) illustrates how user specified weights and industry or other forms of benchmark data may be used as inputs to a process or set of logic to determine the weights 302 to be assigned to each task or project metric or risk vector. The process or set of logic executed my comprise combining the user specified weights and benchmark data into a single weight (such as by a normalized addition, multiplication, or scaling process), selecting the highest value of the two weights, selecting an average value of the two weights, fitting the weights to a curve or function, etc.

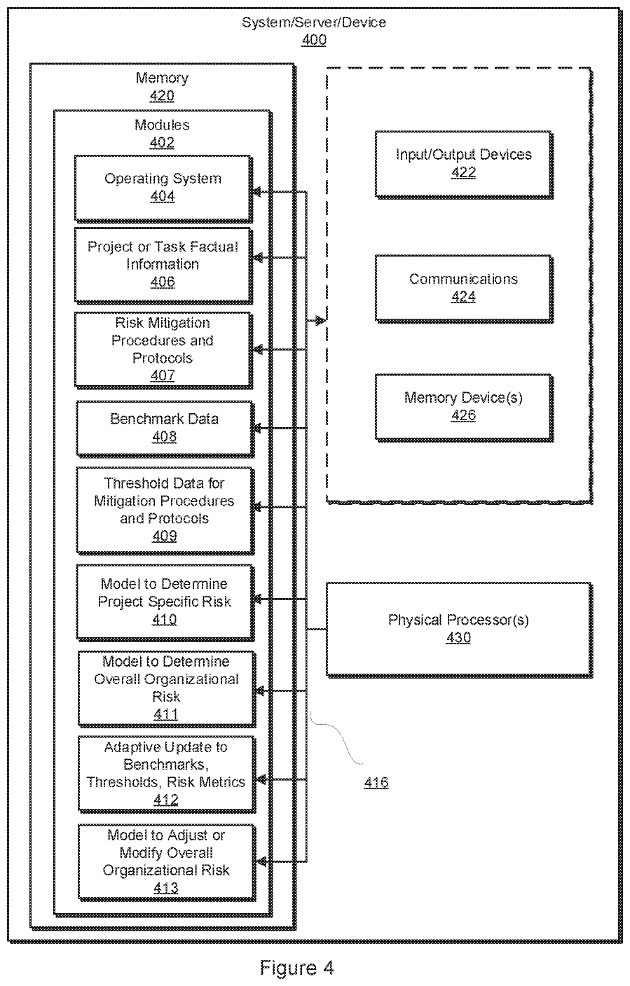

FIG. 4 is a diagram illustrating elements or components that may be present in a computer device, server, or system 400 configured to implement a method, process, function, or operation in accordance with some embodiments. As noted, in some embodiments, the inventive system and methods may be implemented in the form of an apparatus that includes a processing element and set of executable instructions. The executable instructions may be part of a software application and arranged into a software architecture. In general, an embodiment may be implemented using a set of software instructions that are designed to be executed by a suitably programmed processing element (such as a GPU, TPU, CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

A module or sub-module may contain instructions that are executed by a processor contained in more than one of a server, client device, network element, system, platform, or other component. Thus, in some embodiments, a plurality of electronic processors, with each being part of a separate device, server, or system may be responsible for executing all or a portion of the software instructions contained in an illustrated module. Thus, although FIG. 4 illustrates a set of modules which taken together perform multiple functions or operations, these functions or operations may be performed by different devices or system elements, with certain of the modules (or instructions contained in those modules) being associated with those devices or system elements.

Each application module or sub-module may correspond to a specific function, method, process, or operation that is implemented by the module or sub-module. Such function, method, process, or operation may include those used to implement one or more aspects of the disclosed system and methods, such as for:
Accessing or obtaining information regarding a specific task or project to be evaluated;
   processing the information (if needed) to identify factual indicators/features indicative of potential risk for the project or task—example factual questions used to identify these factors may include:
      How many data processing flows are you creating?
      Will the task processes have an impact on health and human safety?
      Will the task processes be “closed loop” ?
      How many data sources are expected to be utilized as part of executing the task?
Accessing or obtaining information regarding risk control or mitigation procedures or protocols currently being used for the task or project;
   Example Risk Mitigation questions:
      Will you independently verify a processing flow output?
      Will you engage a third party to validate a final processing flow?
      Do you have a model risk management (MRM) approach?
      Do you have a bias framework?
Accessing or obtaining information regarding additional task-specific or organization specific mitigation procedures that may be applicable to a task or set of tasks;
Accessing or obtaining information regarding industry or project specific benchmarks, or other forms of benchmarks indicating a risk score or metric (or a risk vector component) for an industry, organization and/or project having sufficient similarity to the organization or project being evaluated;
Accessing or obtaining information regarding a threshold or set of thresholds representing levels of risk for an organization, project or set of projects that are sufficient to trigger a need for additional risk evaluation and/or mitigation actions;
   the thresholds may be modified by a review process and/or a feedback process from other elements or processes of the system described, including user-specified thresholds or logic;
A rules-based and/or machine learning model that operates to generate a risk score or metric (and/or risk vector) from data and information regarding a specific task or project, including data regarding risk management or mitigation processes currently being utilized;
A rules-based and/or machine learning model that operates to generate a risk score or metric (and/or risk vector) for an organization from data and information regarding a set of tasks or projects, including data regarding risk management or mitigation processes currently being utilized for each project or task, and in some cases, for the organization as a whole;
An iterative process that operates to update one or more of the following based on real-time or pseudo real-time risk evaluations;
   A risk score (or risk vector or component) for an organization or set of tasks or projects;
   A benchmark value for an industry, organization, or project type;
   A threshold or threshold value for a risk score or metric (or risk vector or component) that operates to trigger a further risk evaluation, consideration of a change to (or additional) risk mitigation or other process;
A process to execute or modify logic used to set a risk metric threshold, to decide if additional mitigation is recommended or required when a risk metric exceeds a threshold, or to select an additional mitigation technique.
   Note that one or more of the processes, models, or operations may utilize data and/or metadata related to datasets, processing flows, projects, or organizations as an input to an evaluation function, rule-set, model, or decision logic, which themselves may comprise one or more models, rule-sets, or other logic as described herein.

As shown in FIG. 4, system 400 may represent a server or other form of computing or data processing device. Modules 402 each contain a set of executable instructions, where when the set of instructions is executed by a suitable electronic processor (such as that indicated in the figure by “Physical Processor(s) 430”), system (or server or device) 400 operates to perform a specific process, operation, function or method. Modules 402 are stored in a memory 420, which typically includes an Operating System module 404 that contains instructions used (among other functions) to access and control the execution of the instructions contained in other modules. The modules 402 in memory 420 are accessed for purposes of transferring data and executing instructions by use of a “bus” or communications line 416, which also serves to permit processor(s) 430 to communicate with the modules for purposes of accessing and executing a set of instructions. Bus or communications line 416 also permits processor(s) 430 to interact with other elements of system 400, such as input or output devices 422, communications elements 424 for exchanging data and information with devices external to system 400, and additional memory devices 426.

As shown in the figure, modules 402 may contain one or more sets of instructions for performing a method, process, or function described with reference to FIGS. 1-3 and the description provided in the specification. These modules may include those illustrated but may also include a greater number or fewer number than those illustrated. The set of instructions may be executed by a programmed processor contained in a server, client device, network element, system, platform, or other component. As mentioned, a module may contain instructions that are executed by a processor contained in more than one of a server, client device, network element, system, platform, or other component. Thus, although FIG. 4 illustrates a set of modules which taken together perform multiple functions or operations, these functions or operations may be performed by different devices or system elements, with certain of the modules (or instructions contained in those modules) being associated with those devices or system elements.

As an example, Project or Task Factual Information Module 406 may contain instructions that when executed by a processor or processors cause a system or device to perform a process to access, obtain or generate information and data regarding a specific task or project, such as that indicated by the questions and factors described herein (as suggested by steps or stages 112 and 113 of FIG. 1). Risk Mitigation Procedures and Protocols Module 407 may contain instructions that when executed by a processor or processors cause a system or device to perform a process to access, obtain or generate information and data regarding the risk mitigation processes or protocols available and/or being applied to a specific task, project, or organization (i.e., those at a task, project, or organizational level, depending on the rule-set, model, or logic being applied, as suggested by step or stage 114 of FIG. 1). Benchmark Data Module 408 may contain instructions that when executed by a processor or processors cause a system or device to perform a process to access or obtain information regarding industry, project specific, location, or other benchmarks (as suggested by step or stage 114 of FIG. 1). These benchmarks may be in the form of a risk score or metric for an industry, location, organization and/or project having sufficient similarity to the organization or project being evaluated for risk.

Threshold Data for Mitigation Procedures and Protocols Module 409 may contain instructions that when executed by a processor or processors cause a system or device to perform a process to access, determine, calculate, or otherwise obtain a threshold or other indicator of a risk score or level that will cause a particular mitigation procedure or protocol to be recommended or required (as suggested by step or stage 114 of FIG. 1). As mentioned, these thresholds may be provided by a model or rule-set, user inputs, or based on benchmark data, and be altered or updated as a result of other steps of the overall risk evaluation analysis.

Model to Determine Project Specific Risk Module 410 may contain instructions that when executed by a processor or processors cause a system or device to perform a process to generate, calculate or otherwise determine a risk score, risk level, risk vector, or other form of risk metric for a specific task or project (as suggested by step or stage 115 of FIG. 1). The model may be one or more of a rules-based model, a neural network, or a trained machine learning model. Model to Determine Overall Organizational Risk Module 411 may contain instructions that when executed by a processor or processors cause a system or device to perform a process to generate, calculate or otherwise determine a risk score, risk level, risk vector, or other form of risk metric for an organization as a whole resulting from the risks associated with a plurality of tasks or projects (as suggested by step or stage 122 of FIG. 1). The model may be one or more of a rules-based model, a neural network, or a trained machine learning model.

Adaptive Update to Benchmarks, Thresholds, Risk Metrics Module 412 may contain instructions that when executed by a processor or processors cause a system or device to perform a process to update one or more of (as suggested by steps or stages 119 and 127 of FIG. 1):
an organization, project, or industry benchmark
   which may be based on new data or data sources and reflect current benchmark values for an industry, location, type of project, etc. with regard to overall risk or a risk vector component;
a threshold or triggering value for requiring or recommending a new or modified risk mitigation procedure or protocol
   which may include execution of a logical process based on benchmark, user preference, or organizational practices data or information
a task, project or overall organizational risk metric or risk vector
   such an update to a risk metric or risk vector will typically be the result of re-executing the appropriate risk model due to the adoption of a new mitigation technique or process, modification of an existing mitigation technique being applied to a task or at an organizational level, introduction of a current organizational preference regarding risk, etc.

Model to Adjust or Modify Overall Organizational Risk Module 413 may contain instructions that when executed by a processor or processors cause a system or device to perform a process to enable a user or logic to modify a value of a risk metric or risk vector to account for current benchmark data, organizational preferences, or other factors specific to an organization that have not been considered in previous steps or stages of the integrated risk evaluation process (as suggested by steps or stages 132 and 134 of FIG. 1).

For all three models or rule-sets, once a final risk metric is reduced, it may be fed back into the appropriate model as part of new training data (as suggested by steps or stages 111 and 128 of FIG. 1). Although not shown explicitly in FIG. 1, the result of Model 3 may be used with the final output of Model 2 from process 120 (and combined with any adjusting factors) as part of training a model to perform organization specific adjustments to the output of process 120.

Although the threshold values referred to herein are typically a risk metric or risk vector component value, they may also be a way of expressing a project or task characteristic used to trigger a mitigation technique or protocol. For example, a recommended risk mitigation process or protocol may be to adopt a specific mitigation technique when a certain number of data sets are being used, or a certain number of a type of task is being performed. In this type of situation, a threshold may refer to an aspect or feature of a task or organization that is used as a factor in determining whether to recommend or require a mitigation technique, and would also likely be a factor in a model used to generate a risk metric.

In some embodiments, the integrated risk evaluation system and methods described herein may be implemented as separate sets of functions, with each set being accessed by specific people in an organization. For example, each program or project manager may have access to a user interface to enable them to input task or project specific data for use with the first model or to identify a repository or document in which such data may be available. Similarly, the input data for the second model may be provided by certain executives or risk management personnel within an organization who are aware of industry trends, organization-level preferences, etc. Further, the inputs for the third model and the results of the second model may be available to a smaller group of executives and risk management personnel (such CEO, GC, VP of Risk Management) who together may decide on which, if any, modifications to make to the overall risk metric or vector determined by the second model based on current risk approaches, revised or updated benchmark data, guidance from a Board of Directors, feedback from customers or marketing experts, etc.

As an example, the integrated system/platform for managing organizational risk described herein may be provided to users as the following sets of role-specific capabilities and functions:
(1) Task/project specific processes and user interface, including (portions of which may be accessible to project or program managers):
A process or user interface to collect (in some cases to access and process) task specific data
   This may be obtained from project specifications, contracts, memorandum, etc.
   In some examples, this data (or a portion of it) may be obtained by an automated process that applied NLP, OCR, or other techniques to a document and extracts data values or information for insertion into a field of a model
Process/UI to collect information regarding current mitigation processes being used for task
Process/model to generate task risk metric from data and current mitigation processes
Logic to determine if change to current mitigation processes needed
   Process to determine type of change suggested, recommended, or required
Process to determine revised task metric based on task specific data and revised mitigation processes
(2) Organization specific processes and user interface (typically available to Senior Legal, C-Level Executives, or Risk Management Personnel)
User interface showing final (original or revised) risk metrics for all current tasks or for a subset of tasks (such as all tasks related to a specific client, customer, area of technology, region, risk type, those that exceed a specific risk level, etc.)
User interface to allow a user to
   specify weights for a desired approach to generating a combination of the task metrics
      may include a default to equal weights or weights based on number of tasks having specific type or level of risk
      may include a default to benchmark weights based on industry, location, potential liability, etc.
User interface to display total combined organizational risk vector and risk metric
   Risk vector may provide total risk metric for each of several categories of risk (regulatory, financial, political, etc.)
   Overall risk metric may be based on a selected definition for the “norm” of a vector, such as Euclidean, etc.
Logic to determine if a change to the organizational-level mitigation processes being applied is needed
   Process to determine type of change suggested, recommended, or required
Process to determine revised overall organizational risk vector and risk metric
(3) Organizational Risk Vector and Risk Metric Adjustments (typically available to Senior Legal, C-Level Executives, or Risk Management Personnel)
User interface to display revised overall organizational risk vector and risk metric
Logic to access benchmark data and display it to user
Logic to allow user to modify risk vector or overall risk metric by scaling, adjusting to reflect benchmark, require specific mitigation, filtering, application of threshold, etc. and then to update calculations
   This process may take into consideration more current benchmark or organization specific data than was available to other stages of the processing and/or allow an organization to introduce specific concerns to modify the risk associated with a set of tasks or the organization as a whole.
      The output of this stage may be used to set thresholds or other factors in other portions of the processing flow (such as setting an upper limit on total risk allowed, or to trigger certain types of mitigation processes).

As described, actions taken in response to the risk evaluation processes performed by the integrated risk management platform (such as the outputs of the rule-sets or models) may comprise introduction of a new, revised, or additional mitigation process or operational approach. Such a new process may include, but is not limited to one or more of (a) requiring an additional level of review before authorization is given for a product release, project agreement, or sale of a product or service, (b) suggesting a redesign to a task, or to a product or service to reduce risk by implementing a feature or capability in a different manner (such as by modifying, adding, or eliminating a capability or product feature), (c) renegotiating the terms of a proposed agreement or task description, (d) requiring a change to an existing risk-related reserve fund or escrow account to provide greater resources in case of a risk-related event, or (e) triggering a need for additional review or mitigation actions when a change to the risk (or a new risk) presented by a project or deployment (or by multiple projects or deployments) causes the introduction of an additional risk factor or a significant enough change to the overall risk to an organization.

In some embodiments, actions taken in response to the risk evaluation processes performed by the integrated risk management platform may comprise one or more of limiting access to a model, data or project, provision of additional policies or rules regarding use or functionality of the model, data or project, or recommendations related to increased frequency or intensity of audit processes, as examples.

In one sense, the disclosure describes a system and approach for continuous risk assessment that incorporates both changes within the organization's internal environment, including how risk may nonlinearly compound across multiple projects/use cases, as well as changes external to an organization (e.g., new regulations, benchmark data on mitigation efforts taken by their peers for similar use cases). The disclosed approach or risk management methodology includes a general framework that can be tailored across use cases, industries and jurisdictions based on input from those with relevant experience. The approach applies the risk framework and the associated risk mitigation efforts to new uses cases while also collecting “benchmark” data on existing mitigation efforts, risk tolerance, and risk events to further tailor the risk approach to specific tasks and organizations.

The system and methods described herein serve to embed risk/legal experts and technology experts in a common platform, addressing and solving risk and legal considerations in real time, proportional to the risk in a particular task or set of tasks, and benchmarked against the organization's industry practices for similar use cases. The tools and methodology also capture what is learned about and metrics of an organization's activities, allowing an organization to focus on the risks that actually exist as opposed to hypothetical risks.

This disclosure includes the following embodiments and clauses:

Clause 1. A method for the management of organizational risk, comprising:

for each of a plurality of tasks or projects
acquiring information describing the task or project;
acquiring information describing the risk mitigation practices currently used for the task or project;
inputting the information describing the task or project and the information describing the risk mitigation practices currently used for the task or project into a first model, the first model configured to generate an output representing a measure of the risk associated with the task or project;
determining if the output of the first model exceeds a first threshold risk value;
if the output of the first model exceeds the first threshold risk value, then determining whether the risk mitigation practices currently used for the task or project should be changed;
if it is determined that the risk mitigation practices currently used for the task or project should be changed, then generating a recommended mitigation practice for the task or project;
if the recommended mitigation practice is adopted, then generating a revised measure of the risk associated with the task or project based on inputting the information describing the task or project and the information describing the risk mitigation practices currently used for the task or project, including the recommended mitigation practice, into the first model;

for each of the plurality of tasks or projects, selecting either the revised measure of the risk associated with the task or project or the measure of the risk associated with the task or project as an input for a second model, the second model configured to generate an output representing an overall organizational risk from the plurality of tasks or projects based on the input to the second model for each of the plurality of tasks or projects and information describing the risk mitigation practices currently used for the plurality of tasks or projects as a group;

determining if the overall organizational risk from the plurality of tasks or projects exceeds a second threshold risk value;
if the overall organizational risk from the plurality of tasks or projects exceeds the second threshold risk value, then determining if the risk mitigation practices currently used for the plurality of tasks or projects as a group should be changed;
if it is determined that the risk mitigation practices currently used for the plurality of tasks or projects as a group should be changed, then generating a recommended mitigation practice for the plurality of tasks or projects as a group;
if the recommended mitigation practice for the plurality of tasks or projects as a group is adopted, then generating a revised overall organizational risk from the plurality of tasks or projects based on inputting the selected revised measure of the risk associated with the task or project or the measure of the risk associated with the task or project for each of the plurality of tasks or projects and the risk mitigation practices currently used for the plurality of tasks or projects as a group, including the recommended mitigation practice for the plurality of tasks or projects as a group into the second model; and
selecting either the revised overall organizational risk from the plurality of tasks or projects or the overall organizational risk from the plurality of tasks or projects as an input for a third model, the third model configured to adjust the revised overall organizational risk or the overall organizational risk based on one or more organization specific factors.

Clause 2. The method of clause 1, wherein the information describing the task or project further comprises one or more of a size of an organization, an industry sector of the organization, a jurisdiction in which a dataset originated, a jurisdiction in which the task or project will be deployed, a type of data included in a dataset, a source of a data set, a type of technology being used in the task or project, or a type of environment in which the task or project is deployed.

Clause 3. The method of clause 1, wherein the information describing the risk mitigation practices currently used for the task or project further comprises one or more of an identification of risk mitigation practices currently used, existing risk frameworks, existing risk policies, existing risk mitigation approaches that must be engaged with for the task or project, or existing risk mitigation teams that must be engaged with for the task or project.

Clause 4. The method of clause 1, wherein generating a recommended mitigation practice for the task or project further comprises generating an identification of one or more recommended mitigation practices, wherein the one or more recommended mitigation practices comprise (a) requiring an additional level of review before authorization is given for a product release or project agreement, (b) suggesting a redesign to a product or service to reduce risk by implementing a feature or capability in a different manner, (c) renegotiating the terms of a proposed agreement or task description, (d) requiring a change to an existing risk-related reserve fund or escrow account, or (e) triggering a need for additional review or mitigation actions.

Clause 5. The method of clause 1, wherein generating the recommended mitigation practice for the plurality of tasks or projects as a group further comprises generating an identification of one or more recommended mitigation practices, wherein the one or more recommended mitigation practices comprise a centralized risk assessment and management function, requiring use of a specific technology platform, or requiring use of a specific risk reduction process.

Clause 6. The method of clause 1, wherein the output of the first model is an overall risk value for the task or project, a risk vector comprising a plurality of risk components with each component being a risk value for a risk category associated with that component, or both the overall risk value and the risk vector.

Clause 7. The method of clause 6, wherein the risk category comprises one or more of legal, technological, political, regulatory, intellectual property, privacy, financial, or reputational risk.

Clause 8. The method of clause 1, wherein the first threshold risk value is determined by a user input or benchmark data for a similar task or project.

Clause 9. The method of clause 1, wherein the second model generates the overall organizational risk by combining the output of the first model for each task or project, and further where the combination is a weighted sum where the weight for each output is determined by a user input or a benchmark.

Clause 10. The method of clause 1, further comprising using the revised measure of the risk associated with the task or project or the revised overall organizational risk as training data for the first model or the second model, respectively.

Clause 11. The method of clause 1, wherein the organization specific factors comprise one or more of an increased averseness to risk or to a specific component of the overall risk vector, availability of updated or more specific benchmark data, a regulatory change, customer or vendor concerns, newly identified risk factors, newly important organizational initiatives, or an estimate of potential liability.

Clause 12. The method of clause 1, wherein the first and second models are a rule-set or a trained machine learning model.

Clause 13. The method of clause 1, further comprising providing a display for inputting information describing a specific task or project into the first model to a program manager for the specific task or project.

Clause 14. A system for the management of organizational risk, comprising:
one or more electronic processors configured to execute a set of computer-executable instructions; and
the set of computer-executable instructions, wherein when executed, the instructions cause the one or more electronic processors to

for each of a plurality of tasks or projects
acquire information describing the task or project;
acquire information describing the risk mitigation practices currently used for the task or project;
input the information describing the task or project and the information describing the risk mitigation practices currently used for the task or project into a first model, the first model configured to generate an output representing a measure of the risk associated with the task or project;
determine if the output of the first model exceeds a first threshold risk value;
if the output of the first model exceeds the first threshold risk value, then determine whether the risk mitigation practices currently used for the task or project should be changed;
if it is determined that the risk mitigation practices currently used for the task or project should be changed, then generate a recommended mitigation practice for the task or project;
if the recommended mitigation practice is adopted, then generate a revised measure of the risk associated with the task or project based on inputting the information describing the task or project and the information describing the risk mitigation practices currently used for the task or project, including the recommended mitigation practice, into the first model;
for each of the plurality of tasks or projects, select either the revised measure of the risk associated with the task or project or the measure of the risk associated with the task or project as an input for a second model, the second model configured to generate an output of an overall organizational risk from the plurality of tasks or projects based on the input to the second model for each of the plurality of tasks or projects and information describing the risk mitigation practices currently used for the plurality of tasks or projects as a group;

determine if the overall organizational risk from the plurality of tasks or projects exceeds a second threshold risk value;
if the overall organizational risk from the plurality of tasks or projects exceeds the second threshold risk value, then determine if the risk mitigation practices currently used for the plurality of tasks or projects as a group should be changed;
if it is determined that the risk mitigation practices currently used for the plurality of tasks or projects as a group should be changed, then generate a recommended mitigation practice for the plurality of tasks or projects as a group;
if the recommended mitigation practice for the plurality of tasks or projects as a group is adopted, then generate a revised overall organizational risk from the plurality of tasks or projects based on inputting the selected revised measure of the risk associated with the task or project or the measure of the risk associated with the task or project for each of the plurality of tasks or projects and the risk mitigation practices currently used for the plurality of tasks or projects as a group, including the recommended mitigation practice for the plurality of tasks or projects as a group into the second model; and

select either the revised overall organizational risk from the plurality of tasks or projects or the overall organizational risk from the plurality of tasks or projects as an input for a third model, the third model configured to adjust the revised overall organizational risk or the overall organizational risk based on one or more organization specific factors.

Clause 15. The system of clause 14, wherein the information describing the task or project further comprises one or more of a size of an organization, an industry sector of the organization, a jurisdiction in which a dataset originated, a jurisdiction in which the task or project will be deployed, a type of data included in a dataset, a source of a data set, a type of technology being used in the task or project, or a type of environment in which the task or project is deployed.

Clause 16. The system of clause 14, wherein the information describing the risk mitigation practices currently used for the task or project further comprises one or more of an identification of risk mitigation practices currently used, existing risk frameworks, existing risk policies, existing risk mitigation approaches that must be engaged with for the task or project, or existing risk mitigation teams that must be engaged with for the task or project.

Clause 17. The system of clause 14, wherein the output of the first model is an overall risk value for the task or project, a risk vector comprising a plurality of risk components with each component being a risk value for a risk category associated with that component, or both the overall risk value and the risk vector, and further wherein the risk category comprises one or more of legal, technological, political, regulatory, intellectual property, privacy, financial, or reputational risk.

Clause 18. The system of clause 14, wherein the set of computer-executable instructions further comprise instructions which cause the one or more electronic processors to provide a display for inputting information describing a specific task or project into the first model to a program manager for the specific task or project.

Clause 19. The system of clause 14, wherein the organization specific factors comprise one or more of an increased averseness to risk or to a specific component of the overall risk vector, availability of updated or more specific benchmark data, a regulatory change, customer or vendor concerns, newly identified risk factors, newly important organizational initiatives, or an estimate of potential liability.

Clause 20. A set of computer-executable instructions that when executed by one or more electronic processors, cause the processors to manage organizational risk by:

for each of a plurality of tasks or projects
acquire information describing the task or project;
acquire information describing the risk mitigation practices currently used for the task or project;
input the information describing the task or project and the information describing the risk mitigation practices currently used for the task or project into a first model, the first model configured to generate an output representing a measure of the risk associated with the task or project;
determine if the output of the first model exceeds a first threshold risk value;
if the output of the first model exceeds the first threshold risk value, then determine whether the risk mitigation practices currently used for the task or project should be changed;
if it is determined that the risk mitigation practices currently used for the task or project should be changed, then generate a recommended mitigation practice for the task or project;
if the recommended mitigation practice is adopted, then generate a revised measure of the risk associated with the task or project based on inputting the information describing the task or project and the information describing the risk mitigation practices currently used for the task or project, including the recommended mitigation practice, into the first model;

for each of the plurality of tasks or projects, select either the revised measure of the risk associated with the task or project or the measure of the risk associated with the task or project as an input for a second model, the second model configured to generate an output of an overall organizational risk from the plurality of tasks or projects based on the input to the second model for each of the plurality of tasks or projects and information describing the risk mitigation practices currently used for the plurality of tasks or projects as a group;

determine if the overall organizational risk from the plurality of tasks or projects exceeds a second threshold risk value;
if the overall organizational risk from the plurality of tasks or projects exceeds the second threshold risk value, then determine if the risk mitigation practices currently used for the plurality of tasks or projects as a group should be changed;
if it is determined that the risk mitigation practices currently used for the plurality of tasks or projects as a group should be changed, then generate a recommended mitigation practice for the plurality of tasks or projects as a group;
if the recommended mitigation practice for the plurality of tasks or projects as a group is adopted, then generate a revised overall organizational risk from the plurality of tasks or projects based on inputting the selected revised measure of the risk associated with the task or project or the measure of the risk associated with the task or project for each of the plurality of tasks or projects and the risk mitigation practices currently used for the plurality of tasks or projects as a group, including the recommended mitigation practice for the plurality of tasks or projects as a group into the second model; and

select either the revised overall organizational risk from the plurality of tasks or projects or the overall organizational risk from the plurality of tasks or projects as an input for a third model, the third model configured to adjust the revised overall organizational risk or the overall organizational risk based on one or more organization specific factors.

Clause 21. The method of clause 1, wherein the information describing the task or project is obtained from a document containing text.

Clause 22. The method of clause 21, further comprising obtaining the information from the document using a process that includes a text interpretation and extraction model.

Clause 23. The method of clause 22, wherein the text interpretation and extraction model is a natural language processing or natural language understanding model.

Clause 24. The method of clause 21, further comprising obtaining the information from the document using an optical a character recognition process.

Clause 25. The method of clause 6, wherein the risk value for the task or project is obtained from the risk vector components using a Euclidean norm.

Clause 26. The method of clause 6, wherein the risk value for the task or project is obtained from the risk vector components using a non-Euclidean norm.

Clause 27. The method of clause 1, comprising providing a display for inputting information into the second model or into the third model to a person responsible for overseeing the risk management program for the organization.

Clause 28. The method clause 1, wherein, wherein the second threshold risk value is determined by a user input or benchmark data for a similar organization.

Clause 29. The method of clause 28, wherein the similar organization is one of a similar size, location, industry, or growth rate.

Clause 30. The system of clause 14, wherein the one or more electronic processors comprise at least one processor that is part of a computing device located on a remote platform.

Clause 31. The system of clause 14, wherein the one or more electronic processors comprise at least one processor that is part of a computing device located within the organization.

Clause 32. The set of computer-executable instructions of clause 20, wherein at least some of the instructions are provided to the one or more electronic processors over a network.

Clause 33. The method of clause 1, further comprising generating or implementing a recommended or required action in response to the output of the third model, wherein the recommended or required action comprises one or more of triggering an audit of insurance coverage if the metric exceeds a specified value or falls within a specified range, triggering a cyber audit, or preventing the completion of certain tasks in a workflow management tool until an audit has been completed or a responsible manager has signed off on a task or tasks.

It should be understood that embodiments as described herein can be implemented in the form of control logic using computer software in a modular or integrated manner. Based on the disclosure and teachings provided herein, a person of ordinary skill in the art will know and appreciate other ways and/or methods to implement one or more of the embodiments using hardware and a combination of hardware and software.

In some embodiments, certain of the methods, models or functions described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. A trained neural network, trained machine learning model, or other form of decision or classification process may be used to implement one or more of the methods, functions, processes or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Machine learning (ML) is being used more and more to enable the analysis of data and assist in making decisions in multiple industries. In order to benefit from using machine learning, a machine learning algorithm is applied to a set of training data and labels to generate a “model” which represents what the application of the algorithm has “learned” from the training data. Each element (or example, in the form of one or more parameters, variables, characteristics or “features”) of the set of training data is associated with a label or annotation that defines how the element should be classified by the trained model. A machine learning model is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

Any of the software components, processes or functions described in this application may be implemented as software code to be executed by a processor using any suitable computer language such as Python, Java, JavaScript, C++ or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the embodiment unless otherwise claimed. No language in the specification should be construed as indicating any non-claimed element as essential to each embodiment.

As used herein in the specification, figures, and claims, the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this disclosure. Accordingly, embodiments of the disclosure are not limited to the embodiments described herein or depicted in the drawings, and various embodiments and modifications can be made without departing from the scope of the claims below.

That which is claimed is:

1. A method for the management of organizational risk, comprising:
for each of a plurality of tasks or projects
acquiring information describing the task or project;
acquiring information describing the risk mitigation practices currently used for the task or project;
inputting the information describing the task or project and the information describing the risk mitigation practices currently used for the task or project into a first model, the first model configured to generate an output representing a measure of the risk associated with the task or project;
determining if the output of the first model exceeds a first threshold risk value;
if the output of the first model exceeds the first threshold risk value, then determining whether the risk mitigation practices currently used for the task or project should be changed;
if it is determined that the risk mitigation practices currently used for the task or project should be changed, then generating a recommended mitigation practice for the task or project;
if the recommended mitigation practice is adopted, then generating a revised measure of the risk associated with the task or project based on inputting the information describing the task or project and the information describing the risk mitigation practices currently used for the task or project, including the recommended mitigation practice, into the first model;
for each of the plurality of tasks or projects, selecting either the revised measure of the risk associated with the task or project or the measure of the risk associated with the task or project as an input for a second model, the second model configured to generate an output representing an overall organizational risk from the plurality of tasks or projects based on the input to the second model for each of the plurality of tasks or projects and information describing the risk mitigation practices currently used for the plurality of tasks or projects as a group;
determining if the overall organizational risk from the plurality of tasks or projects exceeds a second threshold risk value;
if the overall organizational risk from the plurality of tasks or projects exceeds the second threshold risk value, then determining if the risk mitigation practices currently used for the plurality of tasks or projects as a group should be changed;
if it is determined that the risk mitigation practices currently used for the plurality of tasks or projects as a group should be changed, then generating a recommended mitigation practice for the plurality of tasks or projects as a group;
if the recommended mitigation practice for the plurality of tasks or projects as a group is adopted, then generating a revised overall organizational risk from the plurality of tasks or projects based on inputting the selected revised measure of the risk associated with the task or project or the measure of the risk associated with the task or project for each of the plurality of tasks or projects and the risk mitigation practices currently used for the plurality of tasks or projects as a group, including the recommended mitigation practice for the plurality of tasks or projects as a group into the second model; and
selecting either the revised overall organizational risk from the plurality of tasks or projects or the overall organizational risk from the plurality of tasks or projects as an input for a third model, the third model configured to adjust the revised overall organizational risk or the overall organizational risk based on one or more organization specific factors.

2. The method of claim 1, wherein the information describing the task or project further comprises one or more of a size of an organization, an industry sector of the organization, a jurisdiction in which a dataset originated, a jurisdiction in which the task or project will be deployed, a type of data included in a dataset, a source of a data set, a type of technology being used in the task or project, or a type of environment in which the task or project is deployed.

3. The method of claim 1, wherein the information describing the risk mitigation practices currently used for the task or project further comprises one or more of an identification of risk mitigation practices currently used, existing risk frameworks, existing risk policies, existing risk mitigation approaches that must be engaged with for the task or project, or existing risk mitigation teams that must be engaged with for the task or project.

4. The method of claim 1, wherein generating a recommended mitigation practice for the task or project further comprises generating an identification of one or more recommended mitigation practices, wherein the one or more recommended mitigation practices comprise (a) requiring an additional level of review before authorization is given for a product release or project agreement, (b) suggesting a redesign to a product or service to reduce risk by implementing a feature or capability in a different manner, (c) renegotiating the terms of a proposed agreement or task description, (d) requiring a change to an existing risk-related reserve fund or escrow account, or (e) triggering a need for additional review or mitigation actions.

5. The method of claim 1, wherein generating the recommended mitigation practice for the plurality of tasks or projects as a group further comprises generating an identification of one or more recommended mitigation practices, wherein the one or more recommended mitigation practices comprise a centralized risk assessment and management function, requiring use of a specific technology platform, or requiring use of a specific risk reduction process.

6. The method of claim 1, wherein the output of the first model is an overall risk value for the task or project, a risk vector comprising a plurality of risk components with each component being a risk value for a risk category associated with that component, or both the overall risk value and the risk vector.

7. The method of claim 6, wherein the risk category comprises one or more of legal, technological, political, regulatory, intellectual property, privacy, financial, or reputational risk.

8. The method of claim 1, wherein the first threshold risk value is determined by a user input or benchmark data for a similar task or project.

9. The method of claim 1, wherein the second model generates the overall organizational risk by combining the output of the first model for each task or project, and further where the combination is a weighted sum where the weight for each output is determined by a user input or a benchmark.

10. The method of claim 1, further comprising using the revised measure of the risk associated with the task or project or the revised overall organizational risk as training data for the first model or the second model, respectively.

11. The method of claim 1, wherein the organization specific factors comprise one or more of an increased averseness to risk or to a specific component of the overall risk vector, availability of updated or more specific benchmark data, a regulatory change, customer or vendor concerns, newly identified risk factors, newly important organizational initiatives, or an estimate of potential liability.

12. The method of claim 1, wherein the first and second models are a rule-set or a trained machine learning model.

13. The method of claim 1, further comprising providing a display for inputting information describing a specific task or project into the first model to a program manager for the specific task or project.

14. A system for the management of organizational risk, comprising:
one or more electronic processors configured to execute a set of computer-executable instructions; and
the set of computer-executable instructions, wherein when executed, the instructions cause the one or more electronic processors to
for each of a plurality of tasks or projects
acquire information describing the task or project;
acquire information describing the risk mitigation practices currently used for the task or project;
input the information describing the task or project and the information describing the risk mitigation practices currently used for the task or project into a first model, the first model configured to generate an output representing a measure of the risk associated with the task or project;
determine if the output of the first model exceeds a first threshold risk value;
if the output of the first model exceeds the first threshold risk value, then determine whether the risk mitigation practices currently used for the task or project should be changed;
if it is determined that the risk mitigation practices currently used for the task or project should be changed, then generate a recommended mitigation practice for the task or project;
if the recommended mitigation practice is adopted, then generate a revised measure of the risk associated with the task or project based on inputting the information describing the task or project and the information describing the risk mitigation practices currently used for the task or project, including the recommended mitigation practice, into the first model;
for each of the plurality of tasks or projects, select either the revised measure of the risk associated with the task or project or the measure of the risk associated with the task or project as an input for a second model, the second model configured to generate an output of an overall organizational risk from the plurality of tasks or projects based on the input to the second model for each of the plurality of tasks or projects and information describing the risk mitigation practices currently used for the plurality of tasks or projects as a group;
determine if the overall organizational risk from the plurality of tasks or projects exceeds a second threshold risk value;
if the overall organizational risk from the plurality of tasks or projects exceeds the second threshold risk value, then determine if the risk mitigation practices currently used for the plurality of tasks or projects as a group should be changed;
if it is determined that the risk mitigation practices currently used for the plurality of tasks or projects as a group should be changed, then generate a recommended mitigation practice for the plurality of tasks or projects as a group;
if the recommended mitigation practice for the plurality of tasks or projects as a group is adopted, then generate a revised overall organizational risk from the plurality of tasks or projects based on inputting the selected revised measure of the risk associated with the task or project or the measure of the risk associated with the task or project for each of the plurality of tasks or projects and the risk mitigation practices currently used for the plurality of tasks or projects as a group, including the recommended mitigation practice for the plurality of tasks or projects as a group into the second model; and
select either the revised overall organizational risk from the plurality of tasks or projects or the overall organizational risk from the plurality of tasks or projects as an input for a third model, the third model configured to adjust the revised overall organizational risk or the overall organizational risk based on one or more organization specific factors.

15. The system of claim 14, wherein the information describing the task or project further comprises one or more of a size of an organization, an industry sector of the organization, a jurisdiction in which a dataset originated, a jurisdiction in which the task or project will be deployed, a type of data included in a dataset, a source of a data set, a type of technology being used in the task or project, or a type of environment in which the task or project is deployed.

16. The system of claim 14, wherein the information describing the risk mitigation practices currently used for the task or project further comprises one or more of an identification of risk mitigation practices currently used, existing risk frameworks, existing risk policies, existing risk mitigation approaches that must be engaged with for the task or project, or existing risk mitigation teams that must be engaged with for the task or project.

17. The system of claim 14, wherein the output of the first model is an overall risk value for the task or project, a risk vector comprising a plurality of risk components with each component being a risk value for a risk category associated with that component, or both the overall risk value and the risk vector, and further wherein the risk category comprises one or more of legal, technological, political, regulatory, intellectual property, privacy, financial, or reputational risk.

18. The system of claim 14, wherein the set of computer-executable instructions further comprise instructions which cause the one or more electronic processors to provide a display for inputting information describing a specific task or project into the first model to a program manager for the specific task or project.

19. The system of claim 14, wherein the organization specific factors comprise one or more of an increased averseness to risk or to a specific component of the overall risk vector, availability of updated or more specific benchmark data, a regulatory change, customer or vendor concerns, newly identified risk factors, newly important organizational initiatives, or an estimate of potential liability.

20. A set of computer-executable instructions that when executed by one or more programmed electronic processors, cause the processors to manage organizational risk by:
for each of a plurality of tasks or projects
acquire information describing the task or project;
acquire information describing the risk mitigation practices currently used for the task or project;
input the information describing the task or project and the information describing the risk mitigation practices currently used for the task or project into a first model, the first model configured to generate an output representing a measure of the risk associated with the task or project;
determine if the output of the first model exceeds a first threshold risk value;
if the output of the first model exceeds the first threshold risk value, then determine whether the risk mitigation practices currently used for the task or project should be changed;
if it is determined that the risk mitigation practices currently used for the task or project should be changed, then generate a recommended mitigation practice for the task or project;
if the recommended mitigation practice is adopted, then generate a revised measure of the risk associated with the task or project based on inputting the information describing the task or project and the information describing the risk mitigation practices currently used for the task or project, including the recommended mitigation practice, into the first model;
for each of the plurality of tasks or projects, select either the revised measure of the risk associated with the task or project or the measure of the risk associated with the task or project as an input for a second model, the second model configured to generate an output of an overall organizational risk from the plurality of tasks or projects based on the input to the second model for each of the plurality of tasks or projects and information describing the risk mitigation practices currently used for the plurality of tasks or projects as a group;
determine if the overall organizational risk from the plurality of tasks or projects exceeds a second threshold risk value;
if the overall organizational risk from the plurality of tasks or projects exceeds the second threshold risk value, then determine if the risk mitigation practices currently used for the plurality of tasks or projects as a group should be changed;
if it is determined that the risk mitigation practices currently used for the plurality of tasks or projects as a group should be changed, then generate a recommended mitigation practice for the plurality of tasks or projects as a group;
if the recommended mitigation practice for the plurality of tasks or projects as a group is adopted, then generate a revised overall organizational risk from the plurality of tasks or projects based on inputting the selected revised measure of the risk associated with the task or project or the measure of the risk associated with the task or project for each of the plurality of tasks or projects and the risk mitigation practices currently used for the plurality of tasks or projects as a group, including the recommended mitigation practice for the plurality of tasks or projects as a group into the second model; and
select either the revised overall organizational risk from the plurality of tasks or projects or the overall organizational risk from the plurality of tasks or projects as an input for a third model, the third model configured to adjust the revised overall organizational risk or the overall organizational risk based on one or more organization specific factors.
